(19) United States
(12) Patent Application Publication
(10) Pub. No.: US 2017/0250929 A1
(43) Pub. Date: Aug. 31, 2017

(54) METHOD AND APPARATUS FOR ACTIVE QUEUE MANAGEMENT FOR WIRELESS NETWORKS USING SHARED WIRELESS CHANNEL

(71) Applicant: ELECTRONICS AND TELECOMMUNICATIONS RESEARCH INSTITUTE, Daejeon (KR)

(72) Inventor: Nam Seok KO, Daejeon (KR)

(21) Appl. No.: 15/440,094

(22) Filed: Feb. 23, 2017

(30) Foreign Application Priority Data
Feb. 29, 2016 (KR) 10-2016-0024186

(51) Int. Cl. H04L 12/861; H04L 12/823; H04L 12/801; H04L 12/875

(52) U.S. Cl. CPC H04L 49/9089; H04L 47/562; H04L 47/32; H04L 47/14; H04W 84/18

(57) ABSTRACT

A method of managing a queue and a communication node that may maintain state information for each flow of a corresponding node, may estimate a time of arrival of each packet of each flow based on flow information that is received from other communication nodes within a collision range and that includes the number of flows and the state information, and may determine dropping and queue scheduling associated with the packets based on the estimated time of arrival (ETA).

### CROSS-REFERENCE TO RELATED APPLICATION(S)

This application claims the priority benefit of Korean Patent Application No. 10-2016-0024186, filed on Feb. 29, 2016, in the Korean Intellectual Property Office, the disclosure of which is incorporated herein by reference for all purposes.

### BACKGROUND

1. Field

One or more example embodiments relate to a method of managing a queue based on a flow in a wireless mesh network and a communication node.

2. Description of Related Art

In the recent wired and wireless networks, a buffer bloat issue causes performance degradation due to excessive packet buffering in a network node and some solutions to the buffer bloat issue are proposed. In particular, a delay controlling algorithm, =CoDel, which is proposed by Van Jacobson, et al., of PARC and a proportional integral controller enhanced (PIE) scheme proposed by Cisco have gained attention as the solution in a wired network field. However, due to characteristics of wireless networks which are different from wired networks, the methods applied to wired networks do not work the same in wireless networks.

### SUMMARY

At least one example embodiment is to solve a buffer bloat issue in a wireless mesh network.

At least one example embodiment is to solve RTT (round trip time) fairness issue in mesh networks.

According to an aspect, there is provided a method of managing a queue, the method including maintaining state information for each flow in each communication node; receiving flow information that includes the number of flows from other communication nodes within a collision range; estimating the time of arrival (ETA) of each packet of each flow based on the received flow information from other communication nodes and the flow state information maintained locally in the communication node; and determining dropping and scheduling associated with the packets based on the ETA.

The estimating may include calculating the effective number of flows based on a sum of the number of flows maintained locally in the communication node and the number of active flows received from the other communication nodes; and estimating the time of arrival of each packet based on the effective number of flows.

The determining may include scheduling the packets of the flow so that the packets share a wireless channel at a fair rate.

The determining may include determining whether to drop the packets based on the ETA; and scheduling packets decided not to be dropped to the queue.

The determining whether to drop the packets may include determining whether to drop packets beyond the ETA based on a deviation of the arrival time of the packet from the ETA and a channel drop probability.

The determining whether to drop the packets may include determining whether to drop the packets based on a flow drop probability associated with packets for each flow and a drop probability weighting factor.

The queue management method may further include generating state information associated with the packets determined not to be dropped; and storing the state information associated with the packets determined not to be dropped.

The determining of the queue scheduling may include calculating a fair rate of flows so that the flows fairly share a wireless channel; and scheduling the packets of the flow based on the fair rate.

The scheduling of the packets of the flow may include calculating a flow drop probability of packets of the flow based on the fair rate; and dropping the packets based on the calculated flow drop probability.

The queue may be a shared memory circular queue configured using multi-time slots with an adjustable length.

According to another aspect, there is provided a communication node including a control plane processor configured to receive flow information that includes the number of flows from other communication nodes within a collision range; a data plane processor configured to maintain state information for each flow, to estimate the time of arrival of each packet of each flow based on the received flow information from other communication nodes and the flow state information maintained locally in the communication node, and to schedule the packets based on the ETA; and a queue configured to store the scheduled packets.

The data plane processor may be further configured to process the packets based on the effective number of flows that is calculated based on a sum of the number of flows maintained locally in the communication node and the number of active flows received from the other communication nodes.

The data plane processor may include an enqueue processor configured to estimate the time of arrival of each packet included in each flow based on the received flow information from other communication nodes and the flow state information maintained locally in the communication node, and to schedule the packets to the queue based on the ETA; and a quality of service (QoS) processor configured to manage variables input to the enqueue processor.

The variables may include at least one of the effective number of flows, an average accepted rate calculated based on an instant accepted rate during the time period of the QoS processor, a residual rate used to calculate the ETA of each packet, and a channel drop probability used to calculate a flow drop probability associated with packets for each flow at the enqueue processor.

The data plane processor may further include a dequeue processor configured to fetch and transmit a non-transmitted packet from the queue when the non-transmitted packet is present in the current time slot or previous time slots.

The enqueue processor may be further configured to calculate the effective number of flows that is calculated based on a sum of the number of flows maintained locally in the communication node and the number of active flows received from the other communication nodes.

The enqueue processor may further be configured to calculate a fair rate of flows so that the flows fairly share a wireless channel, and to schedule the packets of the flow based on the fair rate.

The enqueue processor may further be configured to calculate a flow drop probability associated with packets for each flow based on the fair rate, and to drop the packets based on the calculated flow drop probability.

The queue may be a shared memory circular queue configured using multi-time slots with an adjustable length.

According to example embodiments, it is possible to solve a buffer bloat issue by estimating a time of arrival of each packet included in a flow in a wireless mesh network and by scheduling the packets in a queue based on the ETA.

According to example embodiments, it is possible to solve a fairness issue of an RTT present in a mesh network by scheduling packets included in a flow to share a wireless channel at a fair rate.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates a communication environment including communication nodes according to an example embodiment;

FIG. 2 is a block diagram illustrating a communication node according to an example embodiment;

FIG. 3 illustrates a framework for managing a queue according to an example embodiment;

FIG. 4 illustrates a program coding of an algorithm that represents an operation of an enqueue processor according to an example embodiment;

FIG. 5 is a flowchart illustrating a method of managing a queue according to an example embodiment;

FIG. 6 is a flowchart illustrating a method of managing a queue according to an example embodiment; and

FIG. 7 is a flowchart illustrating a method of scheduling packets according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

When describing the example embodiments with reference to the accompanying drawings, like reference numerals in the drawings refer to like elements throughout and repeated description related thereto is omitted. When it is determined that the detailed description related to the known art may render the example embodiments ambiguous, the detailed description is omitted.

Hereinafter, the term “communication node” may be understood as a meaning that includes various communication devices performing wired/wireless communication, for example, a mobile terminal, an access point, a router, a hub, and the like. Hereinafter, the communication node and a node may be understood as the same meaning.

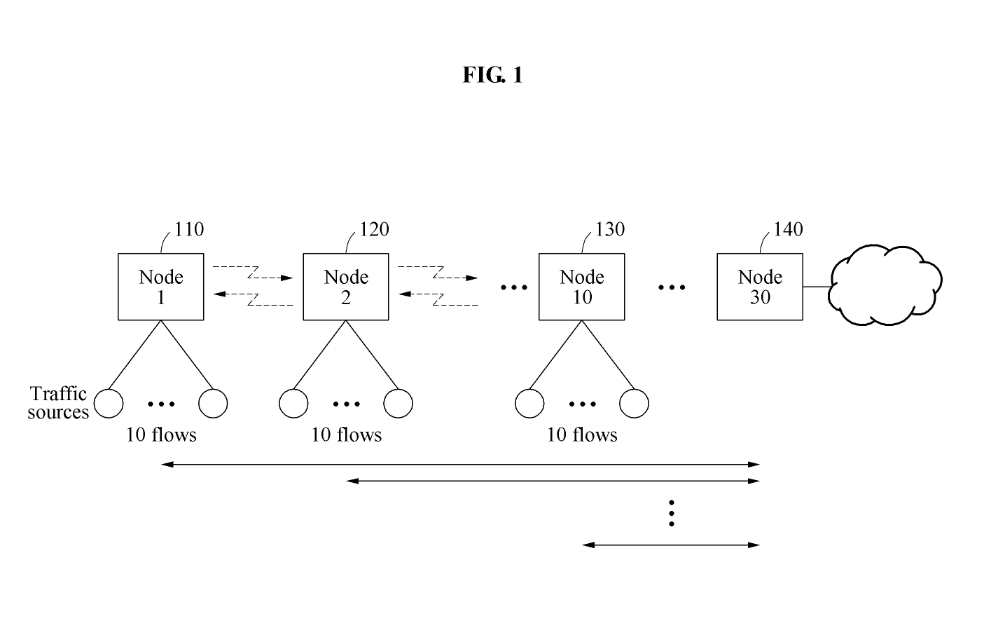

FIG. 1 illustrates a communication environment including communication nodes according to an example embodiment. FIG. 1 illustrates communication nodes 110, 120, 130, and 140 that are included in the same collision range.

For example, it is assumed that each of the communication nodes 110, 120, and 130 transmits 10 flows to the communication node 140. Here, the flows may be transmission control protocol (TCP) flows, or may be user datagram protocol (UDP) flows.

If the communication node 110 among the communication nodes 110, 120, and 130 transmits a packet or a frame to the communication node 140, a collision between the communication node 10 and the other communication nodes 120 and 130 may occur. Here, all of the communication nodes 110, 120, and 130 connected to the communication node 140 may be regarded to be within the ‘same collision range’ or the ‘same collision domain’.

The communication nodes 110, 120, 130, and 140 may communicate in a multiple wireless channel environment. The communication nodes 110, 120, 130, and 140 may be wireless mesh network nodes.

The communication nodes 110, 120, 130, and 140 may manage and share state information for each flow in a network environment in which TCP flows and UDP flows are mixed. The communication nodes 110, 120, 130, and 140 may estimate a time of arrival of a packet based on a total number of active flows received from other communication nodes in the same collision range and the flow state information maintained locally in each communication node. The communication nodes 110, 120, 130, and 140 may drop the packets or schedule the packets in a queue based on the estimated time of arrival (ETA). Here, the term “queue” may be an active queue. The communication nodes 110, 120, 130, and 140 may schedule the packets at a fair rate with respect to a wireless channel. In this manner, round trip time (RTT) fairness may be enhanced.

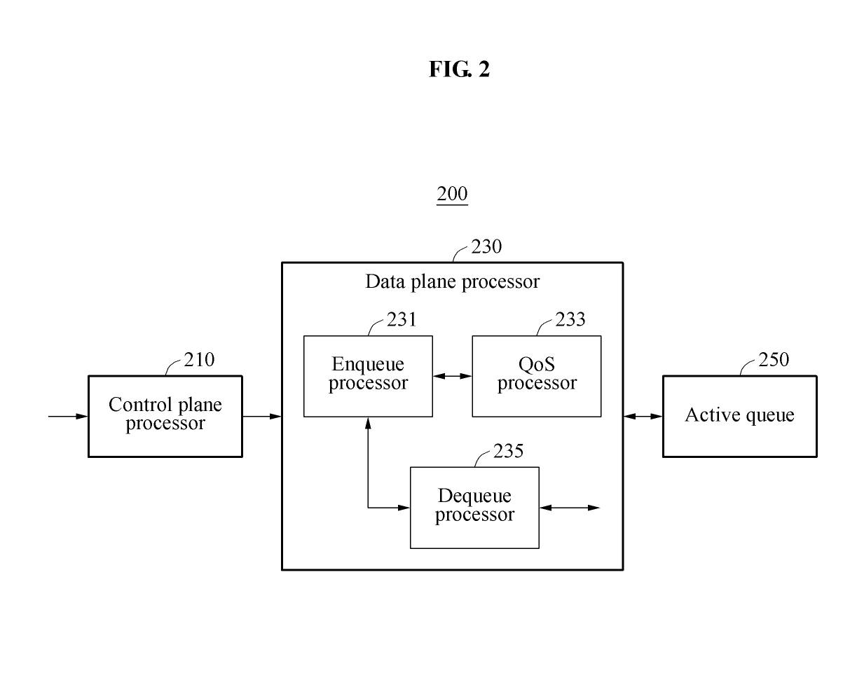

FIG. 2 is a block diagram illustrating a communication node according to an example embodiment. Referring to FIG. 2, a communication node 200 includes a control plane processor 210, a data plane processor 230, and an active queue 250.

The control plane processor 210 receives flow information that includes the number of flows from other communication nodes within a collision range. The control plane processor 210 may share flow information of the communication node 200 with other communication nodes.

The data plane processor 230 maintains state information for each flow and estimates a time of arrival of each packet of each flow based on flow information received from other communication nodes and state information for each flow of the communication node 200. The data plane processor 230 schedules the packets based on the ETA. The data plane processor 230 may process the packets based on the effective number of flows that is calculated based on a sum of the number of flows maintained locally in the communication node 200 and the number of active flows received from the other communication nodes.

The data plane processor 230 includes an enqueue processor 231, a quality of service (QoS) processor 233, and a dequeue processor 235.

The enqueue processor 231 may estimate the time of arrival of each packet of each flow based on flow state information for each flow. The enqueue processor 231 may schedule the packets to an active queue based on the ETA. The enqueue processor 231 may calculate a scheduling time of each packet based on the flow information.

The enqueue processor 231 may calculate the effective number of flows based on a sum of the number of flows maintained in the communication node 200 and the number of active flows received from the other communication nodes. The enqueue processor 231 may estimate the time of arrival of each packet based on the effective number of flows.

The enqueue processor 231 may calculate a fair rate of flows so that the flows may fairly share a wireless channel. The enqueue processor 231 may schedule packets of the flow based on the fair rate.

The enqueue processor 231 may calculate a flow drop probability associated with packets for each flow based on the fair rate. The enqueue processor 231 may drop the packets based on the flow drop probability.

The QoS processor 233 may manage variables input to the enqueue processor 231. The variables may include at least one of, for example, the effective number of flows, an average accepted rate, a residual rate, and a channel drop probability. The QoS processor 233 may perform QoS-related functions.

The effective number of flows may calculate based on the number of flows maintained locally in a communication node and the number of flows of other communication nodes received from neighboring communication nodes in the same collision range. That is, the effective number of flows may be understood as a total number of flows of all of the nodes in the same collision range.

The average accepted rate denotes an input rate of a packet that is scheduled after passing through a packet drop process. The average accepted rate may be calculated based on an instant accepted rate during a time period of the QoS processor 233.

The residual rate denotes a value acquired by subtracting the average accepted rate from an entire wireless interface transmission rate, which is in result an unused capacity of a wireless interface transmission capacity. The residual rate may be used to calculate the ETA of each packet.

The channel drop probability denotes a probability value for determining a drop of a packet that is calculated based on a buffer occupancy rate of a wireless channel, with respect to an input packet. The channel drop probability may be used when the enqueue processor 231 calculates the flow drop probability associated with packets for each flow.

The QoS processor 233 may update a shared data structure for the enqueue processor 231.

If a non-transmitted packet is present in a current time slot or a previous time slot, the dequeue processor 235 may fetch and transmit the packet from the active queue 250.

The active queue 250 stores scheduled packets. The active queue 250 may be a shared memory circular queue configured using multiple time slots with an adjustable length.

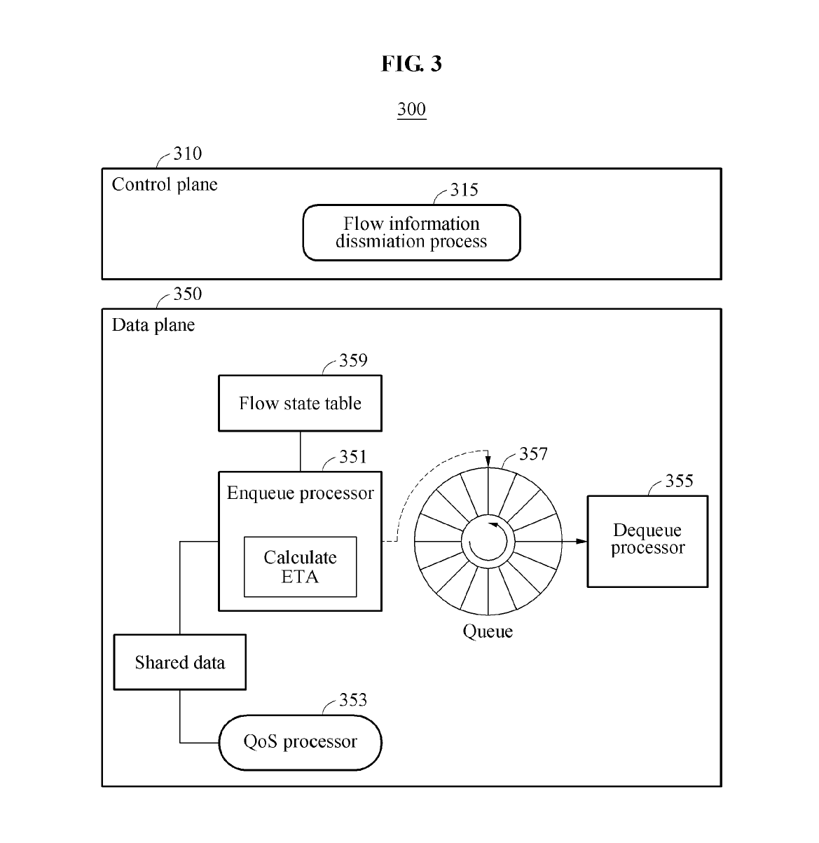

FIG. 3 illustrates a framework for managing an active queue according to an example embodiment. Referring to FIG. 3, a framework 300 includes a control plane 310 and a data plane 350.

The control plane 310 includes a control plane processor 315. The control plane processor 315 may transfer, that is, disseminate flow information to other neighboring communication nodes within the same collision range. The control plane processor 315 may perform dissemination and reception of flow information with the neighboring communication nodes in the same collision range. The flow information is used at an enqueue processor configured to calculate an appropriate scheduling time for each packet.

Depending on example embodiments, a communication apparatus may expand and thereby use a hybrid wireless mesh protocol (HWMP) instead of using the separate control plane processor 315.

The data plane 350 may include three processors, for example, an enqueue processor 351, a QoS processor 353, and a dequeue processor 355. The data plane 350 may include an active queue 357 and a flow state table 359.

The three processors, for example, the enqueue processor 351, the QoS processor 353, and the dequeue processor 355, may directly or indirectly process packets based on the effective number of flows that is a total number of flows including flows of neighboring communication nodes, within, the same collision range.

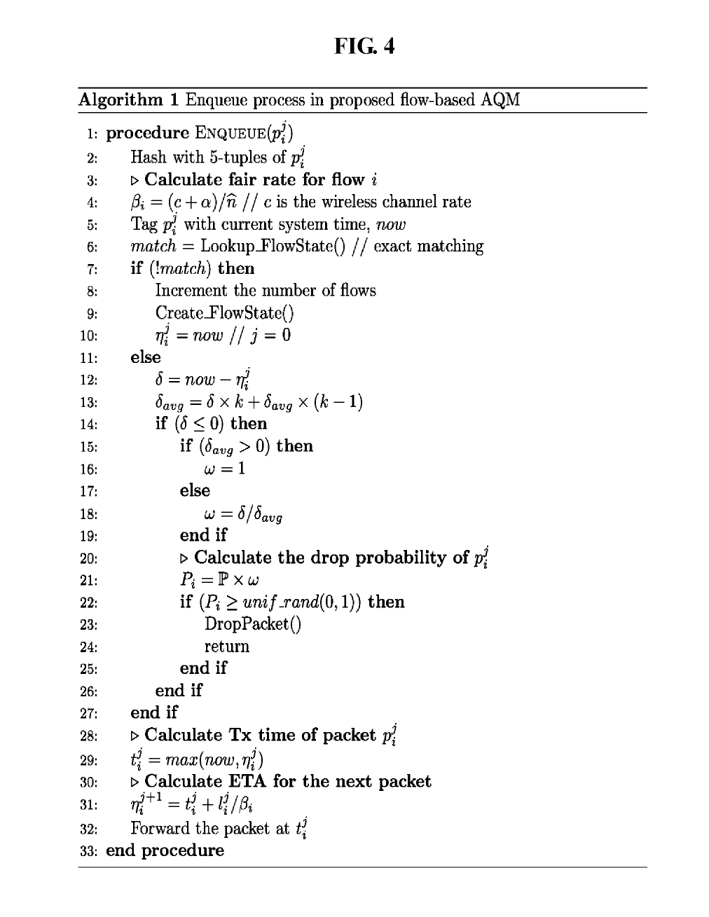

The enqueue processor 351 may calculate an ETA of each packet based on the effective number of channels and may schedule the packets to the active queue 357 based on the estimated ETA so that the packets may fairly, share a channel. The active queue 357 may be a shared memory circular queue configured using multiple time slots with an adjustable length. An operation of the enqueue processor 351 will be described with reference to an algorithm of FIG. 4.

The QoS processor 353 may need to manage four variables input to the enqueue processor 351. First, the effective number of flows may be managed by combining the number of flows maintained locally in a communication node and the number of flows of other communication nodes received from neighboring communication nodes within the collision range. Second, the average accepted rate v is periodically calculated based on an exponential moving average that is calculated based on an instant accepted rate during a time period, for example, 100 ms, of the QoS processor 353. Third, the residual rate α used when the enqueue processor 351 calculates the ETA of each packet is given as Equation 1.

$$α = \{ \begin{matrix}0 , & if ( υ > c ) \\ c - υ , & otherwise\end{matrix} , \qquad [ Equation 1 ]$$

In Equation 1, c denotes a wireless channel transmission rate and v denotes the average accepted rate.

A channel drop probability P is used when the enqueue processor 351 calculates a flow drop probability pi associated with packets for each flow, for example, a flow drop probability of a packet of a flow i, and may be calculated according to Equation 2.

[Equation 2]

P=(qlen−min_th)/(max_th−min_th)

In Equation 2, qlen denotes a current queue length, min_th denotes a minimum threshold, and max_th denotes a maximum threshold.

In an embodiment of the Equation 2, the minimum threshold may be set as 3 folds of an average packet size as a value acquired by multiplying a packet size by a total number of flows, and the maximum threshold may be set as 6 folds of the average packet size as a value acquired by multiplying the packet, size by a total number of flows.

If a non-transmitted packet is present, the dequeue processor 355 may transmit a packet after fetching the packet from the active queue 357 in a current time slot or a previous time slot.

The flow state table 359 may store state information for each flow received from other communication nodes through the control plane processor 315.

FIG. 4 illustrates a program coding of an algorithm that represents an operation of an enqueue processor according to an example embodiment. The enqueue processor may operate as the algorithm of FIG. 4.

To enable fair sharing of a wireless channel between effective flows, a fair rate βᵢ of a flow with respect to an input of a j^{th} packet of an effective flow i is calculated based on a residual rate α and the effective number of flows \hat{n} (Line 4). Here, c denotes a wireless channel transmission rate.

If the j^{th} packet is a first packet of the flow i, an ETA ηᵢ⁰, may be set as a current system time, for example, now. Here, the enqueue processor may create flow state information associated with a flow so that the packet may be immediately transmitted.

However, if a packet is transmitted from an existing flow, the enqueue processor may calculate a deviation δ between an ETA ηᵢ^{j} and an actual time of arrival and an average deviation δavg to determine whether the packet maintains a fair share (Lines 12 and 13).

If the deviation δ between the ETA ηᵢ^{j} and the actual time of arrival is greater than 0, it indicates that the packet has arrived in time or has arrived later than the ETA. In this case, there is no need to drop the packet.

If the deviation δ is less than or equal to 0, it indicates that the actual packet has arrived earlier than the ETA. In this case, the enqueue processor may drop the early arrived packet.

Whether to drop the packet may be performed based on a flow drop probability pi associated with packets for each flow (Line 21). The flow drop probability Pi may be calculated based on a channel drop probability P given by the QoS processor and a drop probability weighting factor ω.

The drop probability weighting factor ω may serve as a tuning knob of the flow drop probability Pi. The flow drop probability Pi may be controlled based on how precisely each flow maintains the fair share or the ETA. The fair share may be represented as a ratio of the deviation δ to the average deviation δavg.

If the average deviation δavg is greater than 0, it indicates that the flows abide by the fair rate on average. Thus, the drop probability weighting factor ω may be set as 1 (Lines 15 and 16).

If a flow transmits some number of packets greater than the fair share, it indicates that the rate of the flow will be deviated from the fair rate of the flow. Accordingly, the deviation δ increases to be greater than the average deviation δavg, and the flow drop probability Pi increases to be greater than other flows which abide by the fair rate.

On the contrary, if the flow transmits some number of packets less than the fair share, the flow drop probability decreases to be less than a flow drop probability of other flows which abide by the fair share.

Packets that are determined not to be dropped in a drop probability test are processed based on the ETA and transmitted. Accordingly, the wireless channel may be fairly shared by multiple flows from various sources that are transferred through a different number of hops.

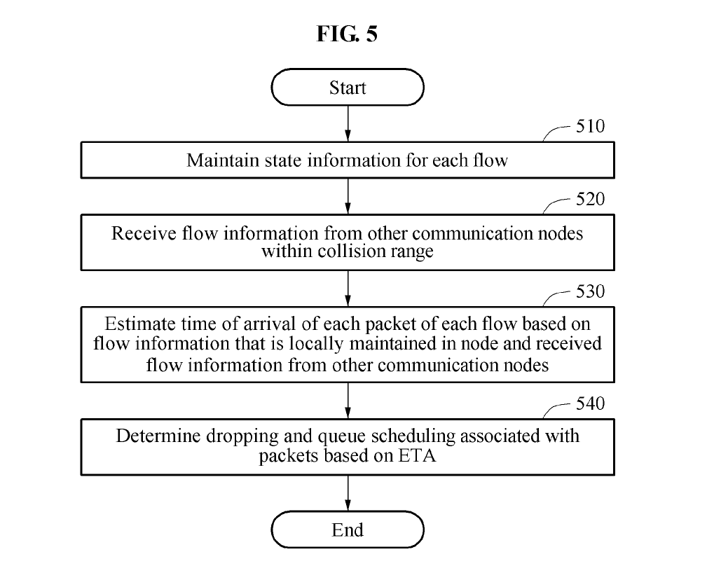

FIG. 5 is a flowchart illustrating a method of managing an active queue according to an example embodiment.

Referring to FIG. 5, in operation 510, a communication node maintains state information for each flow of the communication node.

In operation 520, the communication node receives flow information including the number of flows received from other communication nodes within a collision range. The flow(s) received from the other communication nodes may include TCP flow(s) or UDP flow(s). Flow information may include the number of active flows in each communication node.

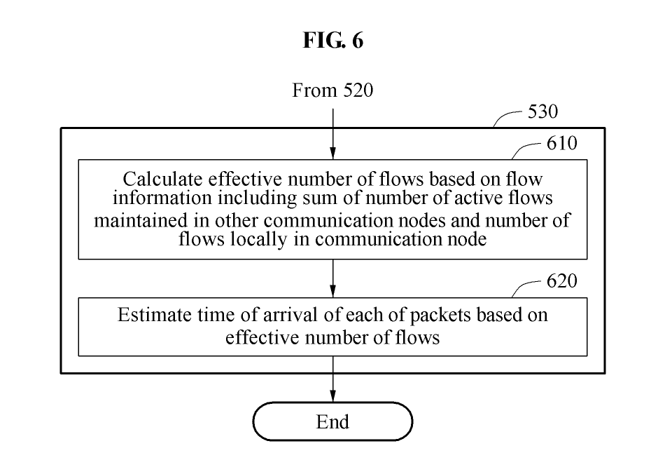

In operation 530, the communication node estimates a time of arrival of each packet of each flow based on the flow state information that is locally maintained in the node and received flow information from other communication nodes. A method of estimating, at the communication node, the time of arrival of each packet will be described with reference to FIG. 6.

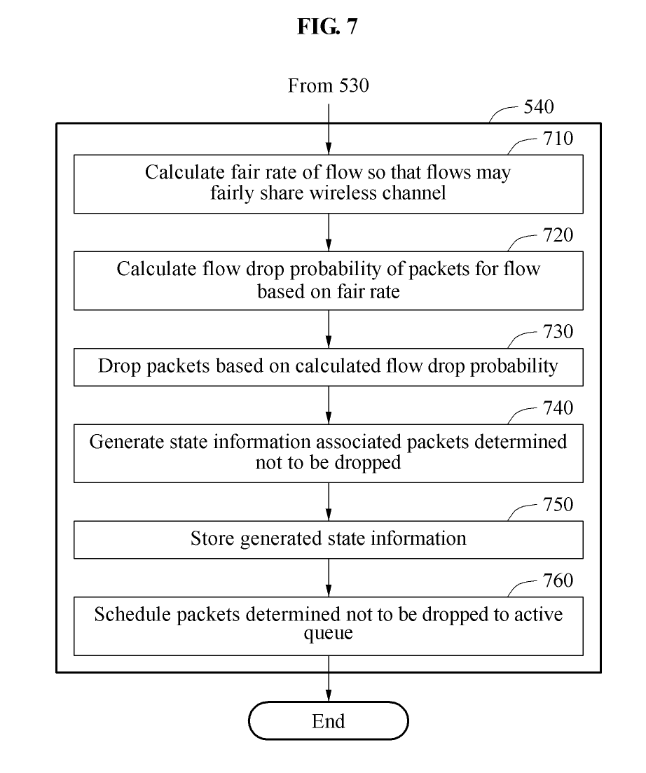

In operation 540, the communication node determines dropping and queue scheduling associated with the packets based on the ETA. The communication node may schedule the packets so that the wireless channel may be fairly shared by active flows, that is, so that the packets of the flow may share the wireless channel at the fair rate. The communication node may determine whether to drop packets based on the ETA and may schedule packets determined not to be dropped to the active queue. A method of scheduling, at the communication node, packets, for example, dropping and queue scheduling associated with the packets will be described with reference to FIG. 7.

FIG. 6 is a flowchart illustrating a method of managing an active queue according to an example embodiment. Referring to FIG. 6, in operation 610, the communication node may calculate the effective number of flows based on flow information including a sum of the number of active flows in other communication nodes and the number of flows maintained locally in the communication node. The other communication nodes may include, for example, all of neighboring communication nodes in the same collision range.

In operation 620, the communication node may estimate the time of arrival of each packet based on the effective number of flows.

FIG. 7 is a flowchart illustrating a method of scheduling packets according to an example embodiment.

Referring to FIG. 7, in operation 710, a communication node may calculate a fair rate of flows so that the flows may fairly share a wireless channel. The communication node may calculate the fair rate based on a residual rate (α) and the effective number of flows. The communication node may schedule packets of the flow based on the fair rate. The communication node may determine whether the packets maintain the fair rate or whether the packets observe the ETA.

In operation 720, the communication node may calculate a flow drop probability of packets of the flow, that is, a flow drop probability associated with packets of each flow based on the fair rate.

In operation 730, the communication node may drop the packets based on the calculated flow drop probability. Here, the communication node may determine whether to drop packets having not observed the ETA based on a deviation between the ETA and an actual time of arrival and a channel drop probability. The channel drop probability may be calculated based on a state of a shared buffer, that is, a state of a shared memory circular queue. The communication node may drop packet(s) having arrived earlier than the ETA.

Also, the communication node may determine whether to drop the packets based on the flow drop probability and the drop probability weighting factor.

The flow drop probability denotes a value given at the QoS processor and may be calculated based on the channel drop probability. The flow drop probability may be controlled based on whether each flow maintains the fair rate. The flow drop probability may be determined based on a ratio between the deviation and the average deviation between the ETA and the actual time of arrival.

In operation 740, the communication node may generate state information associated with packets determined not to be dropped.

In operation 750, the communication node may store the generated state information in, for example, a flow state table and the like.

In operation 760, the communication node may schedule the packets determined not to be dropped to an active queue. The active queue may be a shared memory circular queue configured using multiple time slots with an adjustable length.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of managing a queue, the method comprising:
maintaining state information for each flow of a corresponding node;
receiving flow information that includes the number of flows from other communication nodes within a collision range;
estimating a time of arrival of each packet of each flow based on the received flow information from other communication nodes and the flow state information maintained locally in the communication node; and
determining dropping and scheduling associated with the packets based on the estimated time of arrival (ETA).

2. The method of claim 1, wherein the estimating comprises:
calculating the effective number of flows based on a sum of the number of flows locally maintained in the corresponding node and the number of active flows received from the other communication nodes; and
estimating the time of arrival of each packet based on the effective number of flows.

3. The method of claim 1, wherein the determining comprises:
scheduling the packets of the flow so that the packets share a wireless channel at a fair rate.

4. The method of claim 1, wherein the determining comprises:
determining whether to drop the packets based on the ETA; and
scheduling packets determined not to be dropped to the queue.

5. The method of claim 4, wherein the determining whether to drop the packets comprises:
determining whether to drop packets beyond the ETA based on a deviation between the ETA and an actual time of arrival and a channel drop probability.

6. The method of claim 5, wherein the determining whether to drop the packets comprises:
determining whether to drop the packets based on a flow drop probability associated with packets for each flow and a drop probability weighting factor.

7. The method of claim 4, further comprising:
generating state information associated with the packets determined not to be dropped; and
storing the state information associated with the packets determined not to be dropped.

8. The method of claim 1, wherein the determining of the queue scheduling comprises:
calculating a fair rate of flows so that the flows fairly share a wireless channel; and
scheduling the packets of the flow based on the fair rate.

9. The method of claim 8, wherein the scheduling of the packets of the flow comprises:
calculating a flow drop probability of packets of the flow based on the fair rate; and
dropping the packets based on the calculated flow drop probability.

10. The method of claim 1, wherein the queue is a shared memory circular queue configured using multi-time slots with an adjustable length.

11. A non-transitory computer-readable recording medium storing a program to implement the method of claim 1.

12. A communication node comprising:
a control plane processor configured to receive flow information that includes the number of flows from other communication nodes within a collision range;
a data plane processor configured to maintain state information for each flow, to estimate a time of arrival of each packet of each flow based on the received flow information from other communication nodes and the flow state information locally maintained in the communication node, and to schedule the packets based on the estimated time of arrival (ETA); and
a queue configured to store the scheduled packets.

13. The communication node of claim 12, wherein the data plane processor is further configured to process the packets based on the effective number of flows that is calculated based on a sum of the number of flows maintained locally in the communication node and the number of active flows received from the other communication nodes.

14. The communication node of claim 12, wherein the data plane processor comprises:
an enqueue processor configured to estimate the time of arrival of each packet included in each flow based on the received flow information from other communication nodes and the flow state information maintained locally in the communication node, and to schedule the packets to the queue based on the ETA; and
a quality of service (QoS) processor configured to manage variables input to the enqueue processor.

15. The communication node of claim 14, wherein the variables comprise at least one of the effective number of flows, an average accepted rate calculated based on an instant accepted rate during a time period of the QoS processor, a residual rate used to calculate the ETA of each packet, and a channel drop probability used to calculate a flow drop probability associated with packets for each flow at the enqueue processor.

16. The communication node of claim 14, wherein the data plane processor further comprises:
a dequeue processor configured to fetch and transmit a non-transmitted packet from the queue when the non-transmitted packet is present in a current time slot or a previous time slot.

17. The communication node of claim 14, wherein the enqueue processor is further configured to calculate the effective number of flows that is calculated based on a sum of the number of flows maintained in the communication node and the number of active flows received from the other communication nodes.

18. The communication node of claim 14, wherein the enqueue processor is further configured to calculate a fair rate of flows so that the flows fairly share a wireless channel, and to schedule the packets of the flow based on the fair rate.

19. The communication node of claim 14, wherein the enqueue processor is further configured to calculate a flow drop probability associated with packets for each flow based on the fair rate, and to drop the packets based on the calculated flow drop probability.

20. The communication node of claim 12, wherein the queue is a shared memory circular queue configured using multi-time slots with an adjustable length.
